(19) United States
(12) Patent Application Publication
(10) Pub. No.: US 2004/0168320 A1
(43) Pub. Date: Sep. 2, 2004

(54) Plate and tube join and method

(76) Inventor: Ronald Malcolm Bond Sanderson, Lower Hutt (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/473,027

(22) PCT Filed: Mar. 26, 2002
(86) PCT No.: PCT/NZ02/00039

(30) Foreign Application Priority Data
Mar. 27, 2001 (NZ) 510774

(51) Int. Cl. B23P 17/00; B21D 51/16

(52) U.S. Cl. 29/890.08

(57) ABSTRACT

A joined plate and tube includes a plate (12) with an annular neck (13), and a tube (11) extending through the annular neck and including a first reversing fold (14) around a peripheral end of the annular neck, and a second reversing fold (15), such that at least part of the annular neck (13) is held within a substantially S-shaped folded portion (16) of the tube (11). A method of joining a tube (11) to a plate (12) includes providing a tube (11) having a radially outwardly-extending annular portion (27), providing a plate (12) having an annular neck (13) extending therefrom, positioning the tube such that it extends through the annular neck and the annular neck (13) abuts the annular portion (27), and folding the annular portion (27) over the annular neck (13) to hold at least part of the annular neck in a substantially S-shaped portion of the tube.

### 1. FIELD OF THE INVENTION

The present invention relates to a method of joining a plate to a tube, and to a joined plate and tube. More particularly, the invention relates to a method of joining a muffler body end portion to a gas flow tube which extends through the end portion.

### 2. BACKGROUND ART

A muffler generally includes an outer housing and at least one gas flow tube within the housing, and optionally a plurality of baffles or other sound deadening components to attenuate sound in gases flowing through the muffler.

In many muffler designs, the gas flow tube passes from the exterior of the muffler body into the interior of the muffler body through an end portion of the muffler body, such as an end plate.

In automotive mufflers, it is important to keep weight to a minimum, while offering good resistance to corrosion and vibration, while maintaining satisfactory strength. As such, in automotive applications the components are frequently thin-walled to meet the low weight requirement.

Conventionally, the gas flow tube has been connected to the muffler body end portions by welding, and particularly by MIG welding. However, this method of joining the components has a number of disadvantages. Welding introduces heat which may induce strain in the muffler components, and locally reduce the anti-corrosion characteristics of the muffler material. It has been found that such welded regions between the muffler body and the gas flow tube are the usual points of failure in conventional mufflers, due to corrosion.

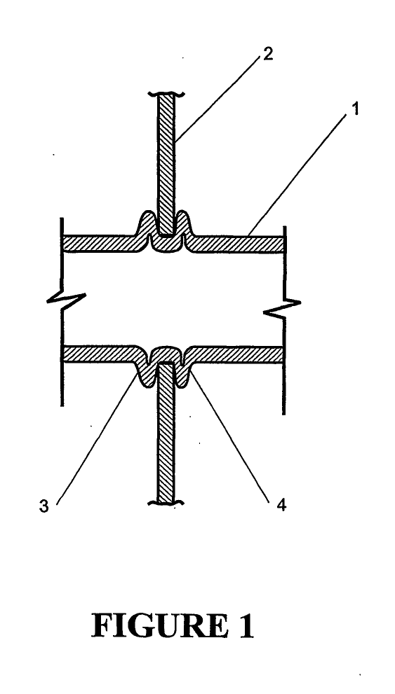

An attempt has been made to address these deficiencies by utilising metal folding rather than welding, and an example of a prior art muffler body end portion and tube join is shown in cross section in FIG. 1. The muffler body end portion 2 surrounds the gas flow tube 1 in a substantially perpendicular arrangement. The muffler body end portion 2 is held in place relative to the gas flow tube by being compressed between two ribs 3, 4 in the gas flow tube 1, one rib being on either side of the end portion 2, thereby forming a W-shaped join. While this method of joining a muffler body end portion to the gas flow tube does not require welding, it has been found that over time the W-shaped join loosens, allowing the end portion 2 to move between the ribs 3,4 and rattle. This movement may also allow the leakage of gas from a muffler which has gas flowing within the muffler body, resulting in reduced efficiency and sound attenuation properties of the muffler.

Another example of a muffler with folded joins is shown in U.S. Pat. No. 5,559,308 to Hayashi.

It is therefore an object of at least a preferred embodiment of the present invention to provide a joined plate and tube, or a method of joining a tube to a plate which may be used for mufflers, and which ameliorates at least one of the disadvantages outlined above, and/or at least provides the public with a useful choice.

### SUMMARY OF THE INVENTION

In accordance with a first aspect of the present invention, there is provided a joined plate and tube, including: a plate having an annular neck extending therefrom; and a tube extending through the annular neck and including a first reversing fold around a peripheral end of the annular neck, and a second reversing fold extending from the first reversing fold, such that at least part of the annular neck is held within a substantially S-shaped folded portion of the tube.

The annular neck preferably extends from the plate peripherally around an aperture through the plate.

Preferably, the tube further comprises a protrusion located adjacent the side of the plate opposite the annular neck to assist in maintaining the at least part of the annular neck within the substantially S-shaped portion. The protrusion is suitably an outwardly-extending annular rib.

In a preferred embodiment, the entire annular neck is held within the substantially S-shaped portion of the tube.

In a particularly preferred embodiment, following the second reversing fold and outside the region of the annular neck, the tube includes a narrowing region such that the diameter of the tube becomes substantially the same as the diameter on the opposite side of the join.

In accordance with a second aspect of the present invention, there is provided a muffler comprising: a muffler body having an end portion having an annular neck extending therefrom; and a gas flow tube extending through the annular neck, the gas flow tube comprising a first reversing fold around a peripheral end of the annular neck, and a second reversing fold extending from the first reversing fold, such that at least part of the annular neck is held within a substantially S-shaped folded portion of the gas flow tube.

The gas flow tube advantageously further comprises a protrusion located adjacent the side of the plate opposite the annular neck. The protrusion is preferably a radially outwardly-extending annular rib. In a preferred embodiment, the entire annular neck is held within the substantially S-shaped folded portion of the gas flow tube.

The gas flow tube advantageously includes a narrowing region following the second reversing fold and outside the region of the annular neck, such that the gas flow tube tapers to a diameter which is substantially the same as the diameter on the opposite side of the join.

The gas flow tube may extend through an opposite end portion of the muffler body. In a preferred embodiment, the opposite end portion of the muffler body has an annular neck extending therefrom and the gas flow tube extends through the annular neck of the opposite end portion, the tube comprising a first reversing fold around a peripheral end of the annular neck, and a second reversing fold extending from the first reversing fold, such that at least part of the annular neck of the opposite end portion is held within a substantially S-shaped folded portion of the tube.

Alternatively, a second gas flow tube passes through an opposite end portion of the muffler body. Preferably, the opposite end portion of the muffler body has an annular neck extending therefrom and the second gas flow tube extends through the annular neck of the opposite end portion, the second tube comprising a first reversing fold around the outer end of the annular neck, and a second reversing fold extending from the first reversing fold, such that at least part of the annular neck of the opposite end portion is held within a substantially S-shaped folded portion of the second tube.

The or each end portion may be an end plate of the muffler body.

In accordance with a third aspect of the present invention, there is provided a method of joining a tube to a plate, including: providing a tube having a radially outwardly-extending annular portion; providing a plate having an annular neck extending therefrom; positioning the tube such that it extends through the annular neck and the annular neck abuts the radially outwardly-extending annular portion of the tube; and folding the radially outwardly-extending annular portion of the tube over the annular neck to hold at least part of the annular neck in a substantially S-shaped portion of the tube.

Preferably, the method further comprises forming a protrusion in the tube adjacent to the plate opposite to the annular neck to assist in maintaining the at least part of the annular neck in the substantially S-shaped portion of the tube. Preferably, the protrusion is in the form of an outwardly-extending annular rib. More preferably, the outwardly-extending annular rib is formed concurrently with the substantially S-shaped portion.

Advantageously, the entire annular neck is held within the substantially S-shaped portion of the tube.

Preferably, the plate is an end portion of a muffler body and the tube is a gas flow tube.

The end portion of the muffler body may be unitary with the muffler body. Alternatively, the end portion may be a separate end plate for connection with an outer body portion of the muffler body.

The method suitably further includes joining the opposite end portion of the muffler body to the tube in the same manner as outlined above. Alternatively, the method may include joining the opposite end portion of the muffler body to another tube, and more preferably in the same manner as outlined above.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

Brief Summary of the Drawings

In order that the invention may be more fully understood, preferred embodiments will now be described by way of example with reference to the accompanying figures in which:

FIG. 1 shows a schematic cross-section of a prior art muffler body end portion and tube join configuration;

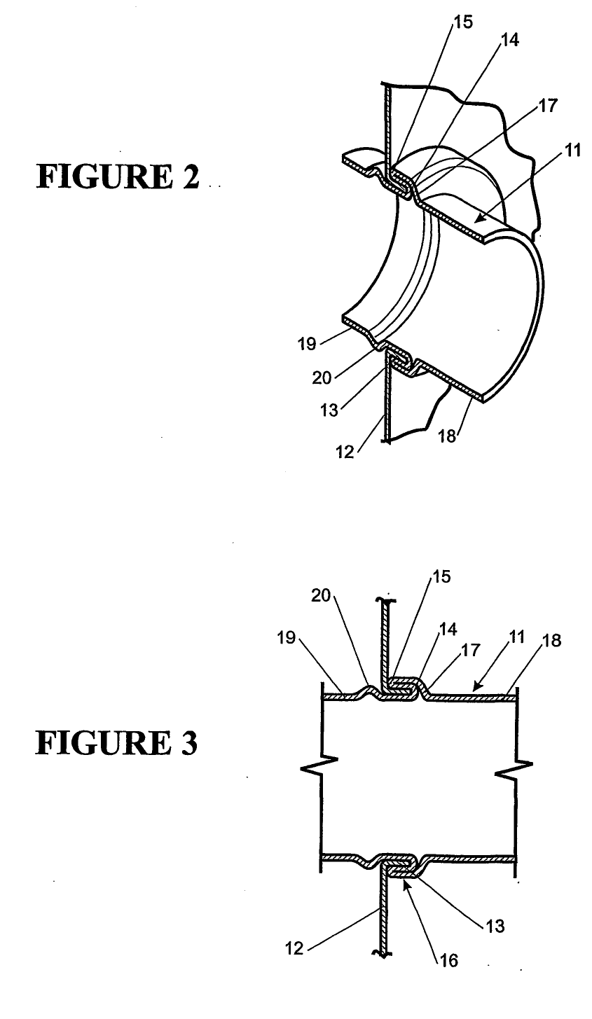

FIG. 2 shows a cross-section of a muffler body end portion and tube join in accordance with a preferred embodiment of the present invention;

FIG. 3 shows a perspective cutaway view the muffler body end portion and tube join of FIG. 2;

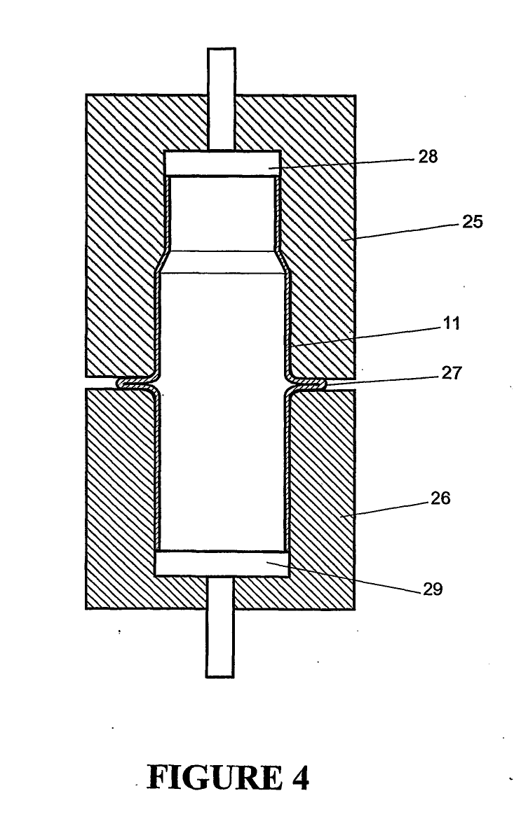

FIG. 4 shows the first stage of a method of joining a muffler body end portion and tube in accordance with a preferred embodiment the present invention;

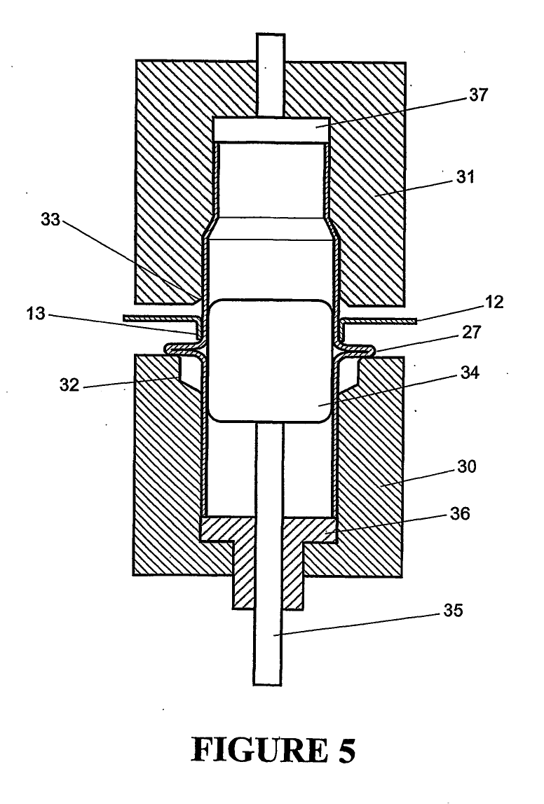

FIG. 5 shows the second stage of a method of joining a muffler body end portion and tube in accordance with a preferred embodiment of the present invention;

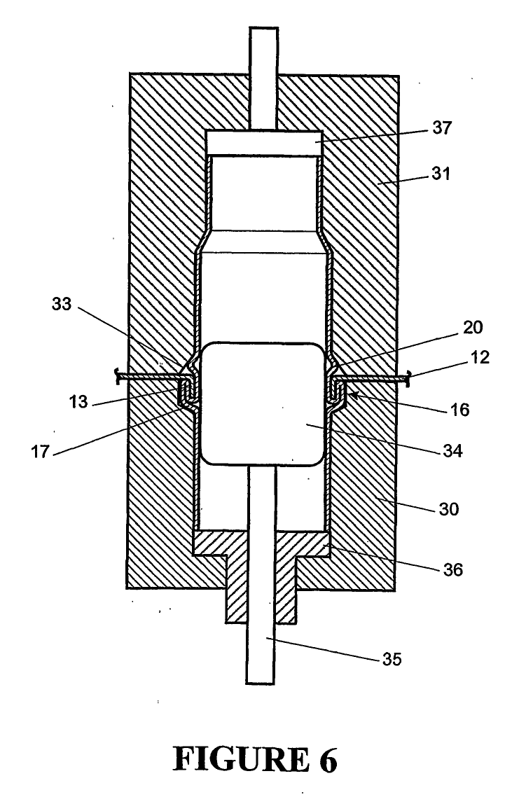

FIG. 6 shows the joined muffler body end portion and tube following the second stage of FIG. 5;

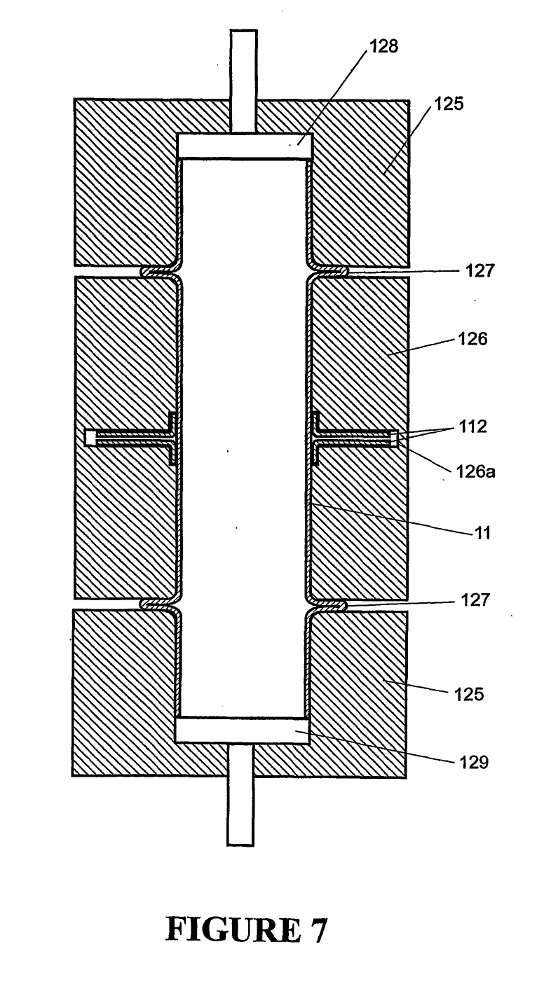

FIG. 7 shows the first stage of a method of simultaneously joining two muffler body end portions to a tube in accordance with a preferred embodiment of the present invention;

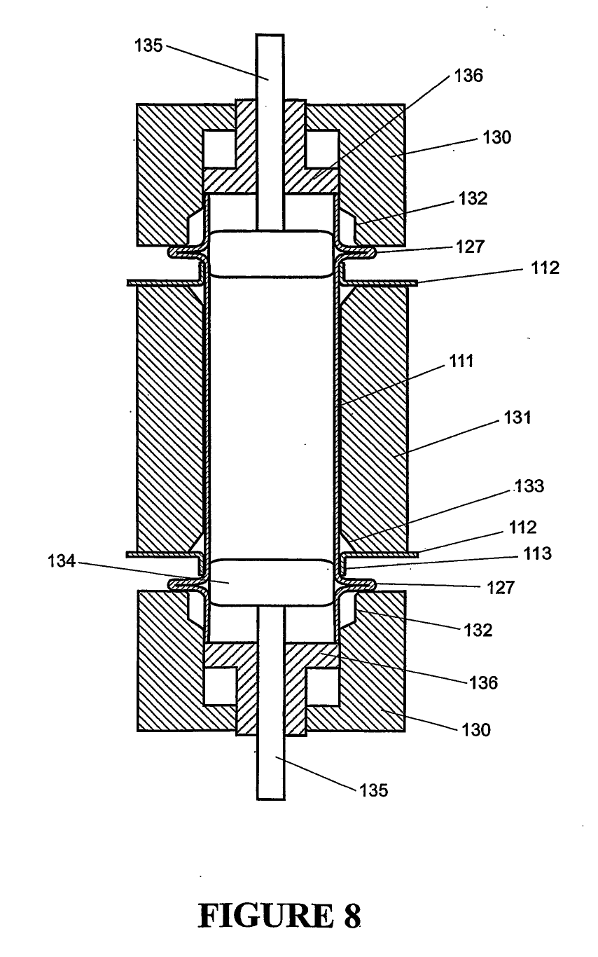

FIG. 8 shows a second stage of a method of joining two muffler body end portions to a tube in accordance with a preferred embodiment of the present invention; and

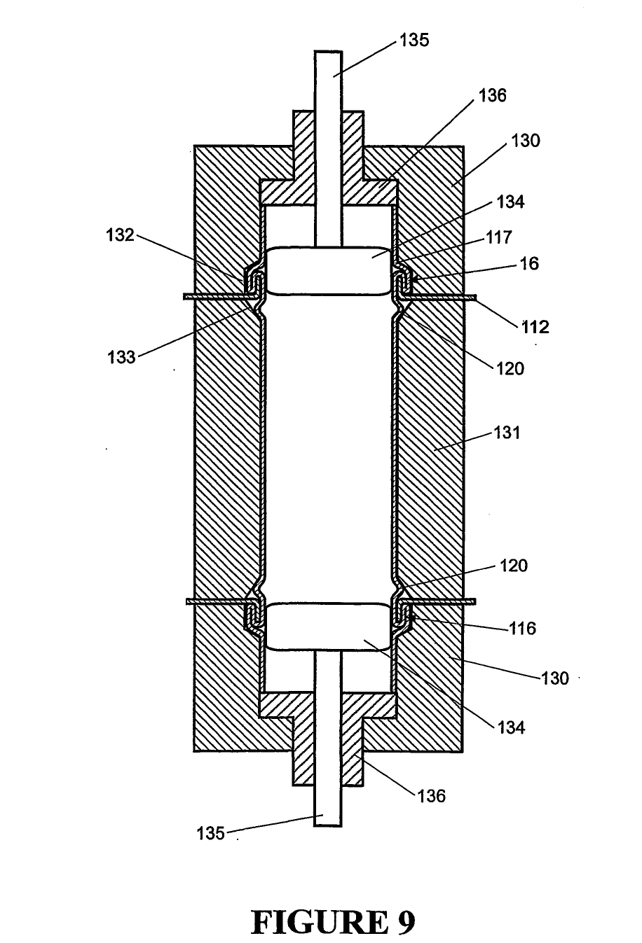

FIG. 9 shows the joined muffler body end portions and tube following the second stage of FIG. 8.

### DETAILED DESCRIPTION OF THE PREFERRED EMBODIMENTS

With reference to FIGS. 2 and 3, the muffler comprises a gas flow tube 11 and a muffler body end portion 12, the muffler body end portion having an annular neck 13 extending therefrom. The gas flow tube extends through the annular neck 13.

The gas flow tube 13 comprises a first reversing fold 14 around the annular neck 13, and a second reversing fold 15 adjacent to the muffler body end portion 12, such that the annular neck 13 is held within a substantially S-shaped portion 16 of the gas flow tube 11.

Adjacent to the muffler body end portion 12 opposite to the annular neck 13, the gas flow tube in the preferred embodiment also includes a radially outwardly-extending protrusion in the form of an annular rib 20, to assist in maintaining the annular neck 13 within the substantially S-shaped portion 16 of the gas flow tube 11.

Adjacent to the S-shaped portion 16, the gas flow tube may include a narrowing region 17 such that the diameter of the portion 18 of the gas flow tube on one side of the join is for the most part substantially the same as the diameter of the portion 19 of the gas flow tube on the other side of the join.

The muffler body end portion 12 may be unitary with the remainder of the muffler body.

In the preferred embodiment, the muffler body end portion 12 is initially separate from the remainder of the muffler body, and may be attached thereto by welding or a folded or lock seam join. For example, the muffler body may be formed with a flange, and the end portion formed with a recess therein. A roller may then roll around the junction between the two parts to form a lock seam.

A method of joining the above muffler body end portion 12 and gas flow tube 11 is shown in FIGS. 4-6, in which like numbers are used to indicate like parts.

With reference to FIG. 4, in the first stage of the method, a gas flow tube 11 is placed within first and second form tools 25, 26, and compressed therein. The first and second form tools 25, 26 are sized such that a space is maintained between the two form tools 25, 26, so that as the tube is compressed between the form tools, a radially outwardly-extending annular portion 27 is formed in the gas flow tube 11.

Once the first stage is completed, the gas flow tube 11 is ejected from the first and second form tools 25, 26 via ejection plugs 28, 29, and the muffler body end portion 12 is placed over the gas flow tube such that the annular neck 13 abuts against the radially outwardly-extending annular portion 27 of the gas flow tube 11.

The gas flow tube is then placed within third and fourth form tools 30, 31 as indicated in FIG. 5. These form tools are shaped differently to the first and second form tools, with the third form tool 30 having an enlarged diameter portion 32 for forming the substantially S-shaped portion of the gas flow tube 11, and the fourth form tool 31 having a filleted portion 33 for forming the annular rib 20.

A mandrel 34 is placed within the gas flow tube 11 so that as the gas flow tube 11 is compressed between the third and fourth form tools 30, 31, it does not collapse inwardly. The mandrel is mounted on a shaft 35.

The third and fourth form tools 30, 31 are closed together as shown in FIG. 6. It can be seen that the movement of the third form tool 30 causes the radially outwardly-extending annular portion 27 of the gas flow tube 11 to be folded over the annular neck 13 of the muffler body end portion 12, resulting in the annular neck 13 being located within the substantially S-shaped portion 16 of the gas flow tube 11. Concurrently, the narrowing region 17 is formed in the gas flow tube between the enlarged diameter portion 32 of the third form tool 30 and the mandrel 34.

Concurrently, the annular rib 20 is formed in the gas flow tube 11 between the filleted region 33 of the fourth form tool 31 and the mandrel 34. This annular rib 20 maintains the annular neck 13 within the substantially S-shaped portion 16 of the gas flow tube 11.

Once this stage has been completed, the joined muffler body end portion and gas flow tube are removed from the third and fourth form tools 30, 31 using ejection plugs 36, 37, and the mandrel 34 is removed from the interior of the gas flow tube 11.

It will be understood that a second gas flow tube may be attached to an end plate at the opposite end of the muffler body using the method described above. Alternatively, the method can be readily modified such that two muffler body end portions are joined to the gas flow tube, either simultaneously or one at a time.

In the embodiment in which the end portion is unitary with the remainder of the muffler body, one or more of the form tools may be sized to fit between the outer part of the muffler body and the gas flow tube, so they can be slidably inserted into an end of the muffler body for the forming operations.

FIGS. 7-9 show how the method can be modified such that two muffler body end plates are simultaneously joined to the gas flow tube, in which like reference numerals are used to indicate like parts to FIGS. 4-6, with the addition of 100.

With reference to FIG. 7, in the first stage of the method, two end portions 112 are placed over a gas flow tube 111, which is then positioned between two end form tools 125. A clam shell-type central form tool 126 which can be selectively opened and closed and having a recess 126a therein is placed over a central portion of the gas flow tube 111 and closed, so that the central portion of the gas flow tube is maintained therein and the end portions 112 are located within the recess 126a. The gas flow tube 111 is compressed between the end form tools 125. The form tools are sized such that a space is maintained between each of the end form tools 125 and the central form tool 126, so that as the tube is compressed between the form tools, two radially outwardly-extending annular portion 127 are formed in the gas flow tube 111.

Once the first stage is completed, the central form tool 126 is opened and removed, and the gas flow tube 111 is ejected from the end form tools 125 via ejection plugs 128, 129.

The gas flow tube is then placed within two further end form tools 130 as shown in FIG. 8. These form tools are shaped differently to the end form tools of FIG. 7, and have an enlarged diameter portion 132 for forming substantially S-shaped portions on the gas flow tube 111. The end portions 112 are positioned such that their annular necks 113 abut the respective annular portions 127 of the gas flow tube 111, and a clam shell-type central form tool 131 is positioned and closed over the central portion of the gas flow tube 111. The central form tool 131 maintains the end portions against the respective annular portions 127. The central form tool 131 has two filleted portions 133 for forming annular ribs 120 on the gas flow tube.

Mandrels 134 are placed within the gas flow tube 111 so that as the gas flow tube 111 is compressed between the form tools 130, 131, it does not collapse inwardly. The mandrels are mounted on shafts 135. It will be understood that the mandrels could be mounted on a single shaft.

The outer form tools 130 are closed towards the central form tool 131 as shown in FIG. 9. It can be seen that the movement of the outer form tools 130 causes the radially outwardly-extending annular portions 127 of the gas flow tube 111 to be folded over the respective annular necks 113 of the muffler body end portions 112, resulting in the annular necks 113 being located within substantially S-shaped portions 116 of the gas flow tube 111. Concurrently, narrowing regions 117 are formed in the gas flow tube between the enlarged diameter portions 132 of the outer form tools 130 and the mandrels 134.

Concurrently, two annular ribs 120 are formed in the gas flow tube 111 between the filleted regions 133 of the central form tool 131 and the mandrels 134. These annular ribs 120 maintain the annular necks 113 within the substantially S-shaped portions 116 of the gas flow tube 111.

Once this stage has been completed, the central form tool 131 is opened and removed, and the joined muffler body end portions and gas flow tube are removed from the end form tools 130 using ejection plugs 136, and the mandrels 134 are removed from the interior of the gas flow tube 111.

The end portions 112 can then be joined to a muffler body (not shown), for example by a lock seam joint.

While the above preferred embodiments have been described with reference to a muffler body end portion and a gas flow tube, it will be appreciated that the present invention is applicable to plate and tube joins in general.

It will be appreciated that a muffler produced with a muffler body end portion and gas flow tube join in accordance with the preferred embodiment has a number of advantages.

In particular, the above described muffler body end portion and gas flow tube join is more corrosion resistant than similar welded joins.

The above described methods of joining the muffler body end portion and gas flow tube are less time consuming than making a similar welded join on a welding machine.

The above described join allows a single gas flow tube to extend through an end portion of the muffler body or through the entire length of the muffler body, resulting in increased strength of the muffler and minimising regions of stress which may exist when the gas flow tube is terminated adjacent the muffler body end portion.

Although the present invention has been described by way of example and with reference to possible embodiments thereof, it is to be understood that modifications may be made thereto without departing from the scope of the following claims.

What I claim is:

1. A joined plate and tube, including:
a plate having an annular neck extending therefrom;
and a tube extending through the annular neck and including a first reversing fold around a peripheral end of the annular neck, and a second reversing fold extending from the first reversing fold, such that at least part of the annular neck is held within a substantially S-shaped folded portion of the tube.

2. The joined plate and tube as claimed in claim 1, wherein the annular neck extends from the plate peripherally around an aperture through the plate.

3. The joined plate and tube as claimed in claim 1 or claim 2, wherein the tube further comprises a protrusion located adjacent the side of the plate opposite the annular neck.

4. The joined plate and tube as claimed in claim 3, wherein the protrusion is a radially outwardly-extending annular rib.

5. The joined plate and tube as claimed in any one of the preceding claims, wherein the entire annular neck is held within the substantially S-shaped folded portion of the tube.

6. The joined plate and tube as claimed in any one of the preceding claims wherein the tube includes a narrowing region following the second reversing fold and outside the region of the annular neck, such that the tube tapers to a diameter which is substantially the same as the diameter on the opposite side of the join.

7. A muffler comprising:
a muffler body having an end portion having an annular neck extending therefrom;
and a gas flow tube extending through the annular neck, the gas flow tube comprising a first reversing fold around a peripheral end of the annular neck, and a second reversing fold extending from the first reversing fold, such that at least part of the annular neck is held within a substantially S-shaped folded portion of the gas flow tube.

8. The muffler as claimed in claim 7, wherein the gas flow tube further comprises a protrusion located adjacent the side of the plate opposite the annular neck.

9. The muffler as claimed in claim 8, wherein the protrusion is a radially outwardly-extending annular rib.

10. The muffler as claimed in any one of claims 7 to 9, wherein the entire annular neck is held within the substantially S-shaped folded portion of the gas flow tube.

11. The muffler as claimed in any one of claims 7 to 10, wherein the gas flow tube includes a narrowing region following the second reversing fold and outside the region of the annular neck, such that the gas flow tube tapers to a diameter which is substantially the same as the diameter on the opposite side of the join.

12. The muffler as claimed in any one of claims 7 to 11, wherein the gas flow tube extends through an opposite end portion of the muffler body.

13. The muffler as claimed in claim 12, wherein the opposite end portion of the muffler body has an annular neck extending therefrom and the gas flow tube extends through the annular neck of the opposite end portion, the tube comprising a first reversing fold around a peripheral end of the annular neck, and a second reversing fold extending from the first reversing fold, such that at least part of the annular neck of the opposite end portion is held within a substantially S-shaped folded portion of the tube.

14. The muffler as claimed in any one of claims 7 to 11, wherein a second gas flow tube passes through an opposite end portion of the muffler body.

15. The muffler as claimed in claim 14, wherein the opposite end portion of the muffler body has an annular neck extending therefrom and the second gas flow tube extends through the annular neck of the opposite end portion, the second tube comprising a first reversing fold around the outer end of the annular neck, and a second reversing fold extending from the first reversing fold, such that at least part of the annular neck of the opposite end portion is held within a substantially S-shaped folded portion of the second tube.

16. The muffler as claimed in any one of claims 7 to 15, wherein the or each end portion is an end plate of the muffler body.

17. A method of joining a tube to a plate, including:
providing a tube having a radially outwardly-extending annular portion;
providing a plate having an annular neck extending therefrom;
positioning the tube such that it extends through the annular neck and the annular neck abuts the radially outwardly-extending annular portion of the tube;
and folding the radially outwardly-extending annular portion of the tube over the annular neck to hold at least part of the annular neck in a substantially S-shaped portion of the tube.

18. The method as claimed in claim 17, further including forming a protrusion in the tube adjacent to the plate opposite to the annular neck.

19. The method as claimed in claim 18, wherein the protrusion is in the form of a radially outwardly-extending annular rib.

20. The method as claimed in claim 19, wherein the radially outwardly-extending annular rib is formed concurrently with the substantially S-shaped portion.

21. The method as claimed in any one of claims 17 to 20, wherein the entire annular neck is held within the substantially S-shaped portion of the tube.

22. The method as claimed in any one of claims 17 to 21, wherein the plate is an end portion of a muffler body and the tube is a gas flow tube.

23. The method as claimed in claim 22, wherein the end portion of the muffler body is unitary with the muffler body.

24. The method as claimed in claim 22, wherein the end portion is a separate end plate, and the method includes connecting the end plate to an outer body portion of the muffler body.

25. The method as claimed in claim 24, wherein the end plate is connected to the outer body portion of the muffler body by a folded join.

26. The method as claimed in any one of claims 17 to 25, wherein the annular neck extends into the inner part of the muffler body in the completed muffler.

27. The method as claimed in any one of claims 17 to 25, wherein the annular neck extends outwardly from the muffler body in the completed muffler.

28. The method as claimed in any one of claims 22 to 27, further including joining an opposite end portion of the muffler body to the gas flow tube by:
providing a further radially outwardly-extending annular portion in the tube;
providing an opposite end portion of the muffler body having an annular neck extending therefrom;
positioning the tube such that it extends through the annular neck of the opposite end portion and the annular neck abuts the further radially outwardly-extending annular portion of the tube;
and folding the further radially outwardly-extending annular portion of the tube over the annular neck of the opposite end portion to hold at least part of the annular neck in a substantially S-shaped portion of the tube.

29. The method as claimed in any one of claims 22 to 27, further including joining an opposite end portion of the muffler body to a further gas flow tube by:
providing a further gas flow tube having a radially outwardly-extending annular portion;
providing an opposite end portion of the muffler body having an annular neck extending therefrom;
positioning the further tube such that it extends through the annular neck of the opposite end portion and the annular neck abuts the radially outwardly-extending annular portion of the further tube;
and folding the radially outwardly-extending annular portion of the further tube over the annular neck of the opposite end portion to hold at least part of the annular neck in a substantially S-shaped portion of the further tube.

30. A method of joining a tube to a plate as claimed in claim 17, substantially as herein described with reference to any embodiment disclosed.

31. A joined plate and tube substantially as hereinbefore described with reference to the accompanying drawings, excepting FIG. 1.

32. A muffler substantially as hereinbefore described with reference to the accompanying drawings, excepting FIG. 1.
